(19) United States
(12) Patent Application Publication
(10) Pub. No.: US 2011/0269862 A1
(43) Pub. Date: Nov. 3, 2011

(54) POLYESTER-BASED POLYURETHANE FOAM WITH IMPROVED STRENGTH AND USES THEREOF

(76) Inventors: Hong Gu You, Gyeonggi-do (KR); Bong Rak Heo, Gyeonggi-do (KR)

(21) Appl. No.: 12/936,468

(22) PCT Filed: Mar. 17, 2009
(86) PCT No.: PCT/KR09/01305

§ 371 Date: Nov. 3, 2010

(30) Foreign Application Priority Data
May 9, 2008 (KR) 10-2008-0043558

(51) Int. Cl. C08L 75/04

(52) U.S. Cl. 521/170

(57) ABSTRACT

The present invention relates to a polyether-based polyurethane foam with improved strength and uses thereof. Since a composition for improving strength is added in a liquid phase to a urethane reaction process which mixes and reacts with raw materials consisting of polyisocyanate and polyol having at least two —OH groups at a terminal of a molecule, the polyether-based polyurethane foam improves mixability (miscibility) between the composition and raw materials which react with each other, thereby maximizing functionality of the composition for improving strength. Furthermore, the polyether-based polyurethane foam with improved strength according to the present invention can be usefully utilized as soundproofing materials or heat insulating materials for building materials and automobiles.

### CROSS-REFERENCE TO RELATED APPLICATIONS

This application claims priority under 35 U.S.C. §119 to Korean Patent Application No. 10-2008-0043558, filed on May 9, 2008, the disclosure of which is incorporated herein by reference in its entirety.

### TECHNICAL FIELD

The present invention relates to a polyether-based polyurethane foam with improved strength and uses thereof, and more particularly, to a polyether-based polyurethane foam which efficiently realizes functionality of the composition to improve strength by adding a composition in a liquid phase to a urethane reaction process which mixes and reacts with raw materials consisting of polyisocyanate and polyol, thereby maximizing miscibility between the composition and raw materials which react with each other, and soundproofing materials or heat insulating materials for building materials and automobiles using the polyether-based polyurethane foam with improved strength.

### BACKGROUND

A urethane bond is formed while alcohol having activated hydroxyl groups (—OH) and isocyanate having isocyanate groups (—N═C═O) generate heat of reaction by the addition polymerization reaction. Namely, isocyanates having one or more isocyanate groups and alcohols having one or more hydroxyl groups are called as polyfunctional groups, the functional groups produce compounds having the structure of —NHCOO— while emitting heat of high temperatures under appropriate conditions, the compounds are called as urethane bonds, and urethane bonds having 1,000 or more molecules bonded therein are called as polyurethanes.

A representative urethane-based synthetic rubber includes Spandex, and the urethane-based synthetic rubber is classified into soft, semi-rigid, and rigid polyester- and polyether-based urethane-based synthetic rubbers.

A polyester-based polyurethane foam is prepared by reacting propylene glycol and ethylene glycol with adipic acid to prepare polyesters and simultaneously urethanizing and polymerizing a polyester which has —OH groups at both ends thereof, and of which molecular weight is up to 3,000 with naphthalene-1 and 5-diisocyanate. Although materials of the polyester-based polyurethane foam prepared by such a method vary a little according to the difference between the soft and rigid materials, the materials of the polyester-based polyurethane foam are low foaming materials compared to materials of a polyether-based polyurethane foam. Therefore, the polyester-based polyurethane foam is mainly used in finished products having high tensile force and hardness.

On the other hand, the polyether-based polyurethane foam as high foaming material is important material widely used in various fields, and the application field of the polyether-based polyurethane foam is expected to expand. Therefore, it has always been required to improve the quality of the polyether-based polyurethane foam. Further, it is being required to improve different properties of the polyether-based polyurethane foam in accordance with the polyether-based polyurethane foam being applied to different application fields. For instance, a polyether-based polyurethane foam used as thermoplastic elastomer is required to represent high modulus of elasticity, excellent low temperature characteristics, low permanent compression strain, excellent surface touch with respect to a finally molded article manufactured from the polyether-based polyurethane foam, and convenience when practically using a coating composition comprising the polyether-based polyurethane foam. Similarly, it has been requested to improve properties of the polyether-based polyurethane foam in industry fields related to soft foams and rigid foams, RIM (Reaction Injection Molding) products, R-RIM (Reinforced-Reaction Injection Molding) products, coating compositions, adhesives, binders, sealants, fiber stocks, artificial leathers and other wide range of polyurethane products, and other various industry fields related to polyurethane urea products. Particularly, the polyether-based polyurethane foam becomes synthetic rubber with good ozone resistance and wear resistance and may be used in the manufacture of automobile tires, and urethane foams having air bubbles contained in polyether-based polyurethane may be used in mattresses and bedding used at home.

However, the polyether-based polyurethane foam has disadvantages that the polyether-based polyurethane foam is easily broken, sunk like sponge, or easily crumbled due to weak tensile force although the polyether-based polyurethane foam has advantages that the polyether-based polyurethane foam is well foamed to enable lightweight products to be produced, and products with lightweight and excellent formability to be produced to increase the application range of the products.

Accordingly, various attempts have been made to improve the disadvantages of the polyether-based polyurethane foam, especially tensile strength while maximizing the advantages of the polyether-based polyurethane foam.

The polyether-based polyurethane foam is prepared from polyisocyanates, high molecular weight diols and low molecular weight diols as principal raw materials, and the polyether-based polyurethane foam is a block copolymer having soft segments mainly consisting of high molecular weight diols and hard segments mainly consisting of polyisocyanates and low molecular weight diols. Due to such a structure, the polyether-based polyurethane foam exhibits rubber elasticity.

A chemical composition for the polyether-based polyurethane foam, and length and secondary and tertiary structures of a polymer block vary according to types of polyisocyanates and high molecular weight diols that have mainly been used and have a great effect on physical properties of a final polyether-based polyurethane foam product.

In general, when performing the urethane bond reaction, a method has been performed, the method comprising adding desired functional additives, e.g., anions, flame retardants and the like in a process of mixing and reacting polyisocyanates and polyols such that the mixture is foamed to make up the disadvantages of polyesther-based polyurethane foam

However, the present invention has a problem that there is no miscibility between a urethane raw material composition and additives since the polyether-based polyurethane foam is prepared by adding the additives in a solid or powder form and forcibly mixing and reacting the additives with a raw material composition, or the polyether-based polyurethane foam cannot obtain expected physical properties since only some of the urethane raw material composition and additives are mixed or reacted with the raw material composition.

Hence, the present inventors have tried to solve problems of the polyether-based polyurethane foam. As the result of their efforts, the inventors have completed the present invention by efficient mixing and reacting the additives with the composition in the urethane reaction process to prepare a polyether-based polyurethane foam with improved strength without using the conventional method of forcibly mixing the additives with the raw material composition.

### SUMMARY

An object of the present invention is to provide a polyether-based polyurethane foam of which functionality is efficiently embodied by adding a liquid composition for improving strength in the urethane reaction process.

Another object of the present invention is to provide a soundproof material for building materials and automobiles using a polyether-based polyurethane foam with improved strength.

Another object of the present invention is to provide an insulating material using the polyether-based polyurethane foam with improved strength.

In order to achieve the foregoing objects, the present invention provides a polyether-based polyurethane foam in which the mixture is foamed in a state that a liquid composition for improving strength is added in a urethane reaction process of mixing and reacting raw materials consisting of polyisocyanate and polyol having at least two —OH groups at a terminal of a molecule.

A polyether-based polyurethane foam of the present invention is prepared by foaming the mixture after adding 30 to 70 weight parts of the liquid composition for improving strength to 100 weight parts of the raw materials.

A liquid composition for improving strength of the present invention is one or more selected from the group consisting of liquid rubber, liquid polyester, ethylene-vinyl acetate copolymer (hereinafter referred to as “EVA”), and liquid waste vinyl.

More specifically, the liquid composition is a liquid composition in which one or more materials selected from the group consisting of the rubber, polyester, EVA and waste vinyl are dissolved into organic solvent, wherein

A polyether-based polyurethane foam of the present invention has its strength improved by encapsulating inner cells of the foam with the composition to improve strength.

The present invention provides a method of preparing a polyether-based polyurethane foam comprising additionally adding a liquid composition for improving strength to the raw materials to perform the urethane reaction process, at the moment when raw materials consisting of polyisocyanate and polyol having at least two —OH groups at a terminal of a molecule are being foamed through the urethane reaction, and drying and curing the resulting material.

A method of preparing a polyether-based polyurethane foam of the present invention comprises a method that the composition to improve strength is first mixed with one of the raw materials consisting of polyisocyanate and polyol having at least two —OH groups at a terminal of a molecule, and then the mixture is subjected to the urethane reaction process.

The composition for improving strength is prepared by dissolving one or more materials selected from the group consisting of rubber, polyester, EVA (Ethylene Vinyl Acetate) and waste vinyl into an organic solvent selected from petroleum-derived organic solvent and methyl ethyl ketone, and 30 to 70 weight parts of the composition for improving strength is added in 100 weight parts of the raw materials.

The present invention provides a soundproofing material for building materials and automobiles using the polyether-based polyurethane foam with improved strength.

The soundproofing material for the building materials is capable of being used by replacing conventional plaster boards, and the soundproofing material for the building materials is capable of being specifically applied to one field selected from an interlayer soundproofing material in the living space, an interlayer soundproofing partition in the office space, a soundproofing mat, and a sound proofing panel in the music room.

Furthermore, the present invention provides an insulating material using the polyether-based polyurethane foam with improved strength.

The present invention is capable of providing a polyether-based polyurethane foam having improved strength which is a weak physical property in conventional polyether-based polyurethane foams by adding a composition for improving strength in a liquid phase to a urethane reaction process of mixing and reacting raw materials consisting of polyisocyanate and polyol, thereby efficiently embodying the functionality of the resulting material.

Further, a polyether-based polyurethane foam having improved strength according to the present invention is capable of being usefully utilized as a soundproofing material or insulating material for building materials and automobiles.

### BRIEF DESCRIPTION OF THE DRAWINGS

The accompanying drawing, which is included to provide a further understanding of the invention and is incorporated in and constitutes a part of this specification, illustrates embodiments of the invention and together with the description serves to explain the principles of the invention.

FIG. 1 is a photograph in which the cross section of a polyether-based polyurethane foam of the present invention is observed by an SEM (Scanning Electron Microscope).

### DETAILED DESCRIPTION OF EMBODIMENTS

Hereinafter, specific embodiments will be described in detail with reference to the accompanying drawing. The present invention may, however, be embodied in different forms and should not be construed as limited to the embodiments set forth herein. Rather, these embodiments are provided so that this invention will be thorough and complete, and will fully convey the scope of the present invention to those skilled in the art.

The present invention provides a polyether-based polyurethane foam in which the mixture is foamed in a state that a liquid composition for improving strength is added in a urethane reaction process of mixing and reacting raw materials consisting of polyisocyanate and polyol.

A polyether-based polyurethane foam of the present invention enables the functionality to be efficiently embodied in a final polyether-based polyurethane foam by adding liquid functional components to the raw materials, thereby improving miscibility with polyisocyanate and polyol used in the urethane reaction process.

Functional components of the present invention may be selected, without particular limitation, from materials for improving weak strength as a physical property, which has been pointed out as a demerit of conventional polyether-based polyurethane foams. However, preferred materials used in the present invention may include one or more selected from the group consisting of rubber, polyester, EVA, and waste vinyl.

More preferably, a composition for improving strength used in the present invention is a liquid composition in which one or more materials selected from the group consisting of rubber, polyester, EVA and waste vinyl are dissolved into organic solvent.

A method of preparing a liquid composition may be selectively performed without limitation in an ordinary manner if the liquid composition can be obtained in a completely dissolved phase. For example, a method of melting the materials by a high temperature furnace or hot air may be used. Most preferably used is a solution prepared by sufficiently dissolving one or more materials selected from the group consisting of rubber, polyester, EVA and waste vinyl into petroleum-derived organic solvent or methyl ethyl ketone. The petroleum-derived organic solvent may include toluene, benzene, and petroleum ether.

An undiluted latex solution may be procured and used as liquid rubber of the present invention, and commercial products may also be used as the liquid EVA. However, liquid polyester or liquid waste vinyl may be prepared by a method selected from the foregoing methods.

Liquid rubber is effective in the improvement of strength, and the liquid rubber is preferable since the liquid rubber as natural material is capable of improving quality of a final product using a polyether-based polyurethane foam.

EVA (Ethylene Vinyl Acetate) copolymer is, as a polymer compound prepared by copolymerization of polyethylene and polyvinyl acetate, evaluated as a relatively environmentally-friendly polymer material by a method of replacing the polymers as environmental regulations on conventional polymers such as polystyrene and the like are intensified. Furthermore, EVA is thermoplastic and effective in the improvement of strength. EVA is widely used as materials for soles and packing as well as bags in the present time by using such properties.

Another example of material improving strength in a state that the material is mixed with raw materials is polyester. In particular, the waste vinyl has economic efficiency in recycling of resources as utilizing merits of polyester, and liquid waste vinyl prepared in a filtrate by sufficiently dissolving waste vinyl into organic solvent has improved strength due to properties of polyester by mixing the liquid waste vinyl with polyester and reacting the liquid waste vinyl with polyester by excellent miscibility in the urethane reaction process of the present invention.

Furthermore, the polyether-based polyurethane foam of the present invention comprises preferably 30 to 70 weight parts of a liquid composition for improving strength added and more preferably 30 to 50 weight parts added out of 100 weight parts of the raw materials in order to optimize the miscibility between the composition and raw materials. There are problems that improving effects of strength to be embodied in a final polyether-based polyurethane foam are insufficient if the liquid composition for improving strength is added in the amount of less than 30 weight parts. By comparison, if the liquid composition for improving strength is added in the amount of more than 70 weight parts, the efficiency with respect to the addition amount decreases due to poor miscibility. The present invention is characterized in that a polyether-based polyurethane foam is provided, wherein the polyether-based polyurethane foam is prepared by foaming the mixture after controlling the curing speed between polyisocyanate and polyol, mixing raw materials with a composition for improving strength into a liquid phase, thereby enabling the raw materials to be efficiently mixed with the composition for improving strength.

Those skilled in the art will naturally understand that curing rate of the urethane reaction can be controlled according to a catalyst selected from ether-based catalysts, ester-based catalysts, elastomers and the like used in an ordinary urethane reaction process. More specifically, the curing rate decreases, the foam is reduced and hardened as the content of polyisocyanate increases while the curing rate increases, the foam is enlarged and softened as the content of polyol increases in the raw materials consisting of polyisocyanate and polyol.

Accordingly, the present invention provides a method of preparing a polyether-based polyurethane foam comprising additionally adding a liquid composition for improving strength to the raw materials to perform the urethane reaction process, at the moment when raw materials consisting of polyisocyanate and polyol are being foamed through the urethane reaction, and drying and curing the resulting material.

A method of preparing a polyether-based polyurethane foam according to the present invention comprises controlling the injection step in the reaction process of a liquid composition for improving strength to prepare the polyether-based polyurethane foam.

A preferred embodiment of the method of preparing a polyether-based polyurethane foam according to the present invention comprises mixing polyisocyanate and polyol, and adding a liquid composition for improving strength to the mixture to perform the urethane reaction process of the resulting material.

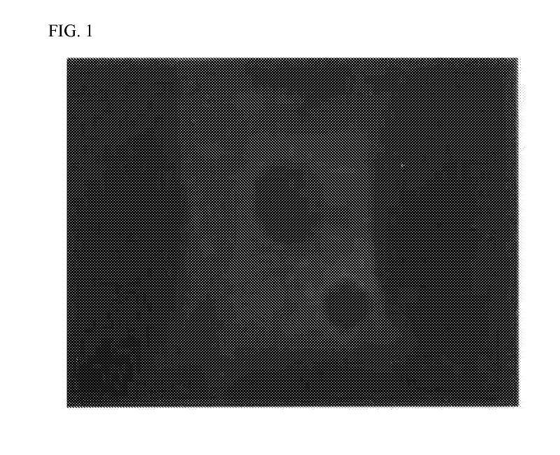

Namely, as shown in FIG. 1, shape of a polyether-based polyurethane foam can be confirmed. Therefore, at the moment when raw materials consisting of polyisocyanate and polyol are being foamed in the urethane reaction, a liquid composition for improving strength is added to the raw materials such that inner cells of the polyether-based polyurethane foam are surrounded by the composition for improving strength to improve strength of the polyether-based polyurethane foam.

In order to increase miscibility between raw materials and a liquid composition for improving strength, the miscibility of the raw materials with a liquid composition for improving strength to be added is maximized by using catalysts employed in an ordinary urethane reaction process and slowing down the curing rate between polyisocyanate and polyol. Components forming polyether urethane are subjected to the melt polymerization in the presence of a proper mixer or preferably an extruder.

Further, a urethane foaming machine comprises a separate circulation chain formed on a polyol line and an isocyanate line such that the undiluted solutions are mixed in the mixing tank when undiluted solutions are injected into the mixing tank in designated quantities while an impeller is being rotated in a mixing tank when pressing a designated button to inject the mixture into a mold.

The foregoing step of injecting a liquid composition for improving strength comprises injecting the liquid composition for improving strength to the raw materials not at a moment that foaming of the mixture is completed, but at a moment that the mixture is foamed in the urethane reaction process of raw materials consisting of polyisocyanate and polyol, wherein it is advantageous to encapsulate the inner cells of the prepared urethane foam if the liquid composition for improving strength is added.

Another preferred embodiment of the method of preparing a polyether-based polyurethane foam according to the present invention comprises performing an ordinary urethane reaction of the mixture after mixing the composition for improving strength with the raw material of polyisocyanate or polyol in an ordinary initial urethane reaction process.

An appropriate process or polymerization reaction starting temperature of diisocyanate is 100 to 200° C. and preferably 100 to 150° C. An appropriate mixing time for reacting various components with one another and forming a polyether-based polyurethane foam of the present invention is ordinarily 2 to 10 minutes, preferably 3 to 5 minutes.

An aliphatic diisocyanate, more preferably an aromatic diisocyanate may be used as polyisocyanate that is one of the raw materials. However, a multifunctional isocyanate compounds causing cross-linking, i.e., triisocyanate and the like are not used.

A preferable content of polyisocyanate is less than 4 mole %, preferably less than 2 mole % based on the total mole of various isocyanates generally used. Diisocyanate may contain about 4 to 20 carbon atoms, preferably about 6 to 16 carbon atoms. Examples of aliphatic diisocyanate may include hexamethylene diisocyanate, isophorone diisocyanate (IPDI), methylene bis(4-cyclohexylisocyanate), 1,4-cyclohexyl diisocyanate (CHDI), and the like. Examples of aliphatic diisocyanate may more preferably include 1,4-diisocyanatobenzene (PPDI), 1,5-naphthalene diisocyanate (NDI), xylene diisocyanate (XDI) and toluene diisocyanate (TDI), isomers thereof, 4,4′-methylenebis(phenylisocyanate), and an isomer or oligomer (collectively known as MDI) thereof. The examples of aliphatic diisocyanate may most preferably include 4,4′-methylenebis(phenylisocyanate), and an isomer or oligomer thereof. In the examples of the present invention, description is limited to 4,4′-methylenebis(phenylisocyanate) (MDI).

Conventional polyether-based polyurethane foams were easily broken due to weak tensile strength. On the other hand, the polyether-based polyurethane foam prepared by reacting the composition with the raw materials after adding a liquid composition for improving strength to raw materials in the urethane reaction process was not broken or dented by a severe external impact while maintaining lightweight characteristics.

The polyether-based polyurethane foam with improved strength of the present invention maintains, as a lightweight thermoplastic elastomer, high elasticity, excellent low temperature characteristics, low permanent compressive strain, and excellent surface touch with respect to a finally molded article manufactured from the polyether-based polyurethane foam. Further, the polyether-based polyurethane foam with improved strength of the present invention may be utilized as a polyether-based polyurethane foam for replacing plaster boards by improving weak strength that is a disadvantage of the conventional polyether-based polyurethane foams.

Accordingly, the polyether-based polyurethane foam with improved strength of the present invention provides uses of a soundproofing material for building materials and automobiles using the polyether-based polyurethane foam.

The soundproofing material for building materials can be selectively applied to an interlayer soundproofing material in the living space of multi-family houses such as apartments, an interlayer soundproofing partition in the office space, a soundproofing mat, and a sound proofing panel in the music room.

Additionally, the polyether-based polyurethane foam of the present invention comprises a composition for improving strength coated on surfaces of conventional foamed open cells to maintain inherent light weight of the polyether-based polyurethane foam and secure resistance to water, wherein the polyether-based polyurethane foam of the present invention is suitable for wood-replacing polyurethane, and the polyether-based polyurethane foam of the present invention is used as floating material such that the polyether-based polyurethane foam can be used as material for ships or artificial islands.

Furthermore, the present invention provides uses of an insulating material using a polyether-based polyurethane foam with improved strength.

Hereinafter, the present invention will be described in more detail with reference to the following examples and experimental examples. However, the following examples and experimental examples are provided for illustrative purposes only, and the scope of the present invention should not be limited thereto in any manner.

### EXAMPLE 1

4,4′ -diphenylmethane diisocyanate (hereinafter referred to as “MDI”) was first mixed with polypropylene glycol (hereinafter referred to as “polyol”) in the equal quantities to agitate and heat the mixture at 80° C., wherein the MDI reacted with water contained in polyol to generate foaming gas (CO2) and form a polyurethane foam. Thereafter, at a moment that the foaming gas was generated, 30 weight parts of an undiluted latex (polyisoprene) solution was injected into the raw materials to additionally agitate the relevant materials and dry the mixture at 80° C. for 10 minutes. And then, the dried material was subjected to the curing process to prepare a polyurethane foam of foamable material.

Products of polyurethane were confirmed in all steps by using an infrared spectrometer (manufactured by Shimadzu Corporation in Japan) after preparing polyurethane by injecting the undiluted latex solution into raw materials of polyol and MDI at a moment that polyol and MDI were reacted to produce and foam polyurethane.

### EXAMPLE 2

A preparation method of the polyurethane foam was performed by the same method as in Example 1 except that 50 weight parts of an undiluted latex (polyisoprene) solution was used with respect to 100 weight parts of raw materials in the preparation step of the polyurethane foam.

### EXAMPLE 3

A preparation method of the polyurethane foam was performed by the same method as in Example 1 except that 70 weight parts of an undiluted latex (polyisoprene) solution was used with respect to 100 weight parts of raw materials in the preparation step of the polyurethane foam.

### COMPARATIVE EXAMPLE 1

A preparation method of the polyurethane foam was performed by the same method as in Example 1 except that 100 weight parts of an undiluted latex (polyisoprene) solution was used with respect to 100 weight parts of raw materials in the preparation step of the polyurethane foam.

### COMPARATIVE EXAMPLE 2

A polyurethane foam was prepared by performing the urethane reaction by the same method as in Example 1 without adding the undiluted latex solution in Example 1.

### EXAMPLE 4

A preparation method of the polyurethane foam was performed by the same method as in Example 1 except that a polyester solution in which polyester was sufficiently dissolved into methyl ethyl ketone was prepared, the polyester solution instead of the undiluted latex solution was added in the preparation step of the polyurethane foam.

### EXAMPLE 5

A preparation method of the polyurethane foam was performed by the same method as in Example 1 except that EVA in the liquid phase instead of the undiluted latex solution was added.

### EXAMPLE 6

The resulting material was agitated and filtered for 90 minutes after preparing 200 g of waste vinyl, washing waste vinyl with water, impregnating the washed waste vinyl with 200 ml of methyl ethyl ketone, and thereby sufficiently eluting the washed waste vinyl into methyl ethyl ketone. A preparation method of the polyurethane foam was performed by the same method as in Example 1 except that the filtrate was concentrated, and waste vinyl in the liquid phase instead of the undiluted latex solution was added in the concentrated filtrate.

### EXAMPLE 7

A preparation method of the polyurethane foam was performed by the same method as in Example 1 except that the urethane reaction was carried out by adding MDI in the mixture after mixing equal quantities of a polyol component and an undiluted latex solution with each other.

### EXPERIMENTAL EXAMPLE 1

### Surface Measurement

The surface of the polyether-based polyurethane foam prepared in Example 1 was observed by using a scanning electron microscope.

It was confirmed that a stable foam shape was maintained in a photograph of FIG. 1 in which the surface of the polyether-based polyurethane foam of the present invention was expanded 1,000 times.

### EXPERIMENTAL EXAMPLE 1

### Hardness Measurement

Hardness values were measured with respect to polyether-based polyurethane foams prepared in the Examples 1 to 7.

A measurement method included adding a liquid composition for improving strength in the urethane reaction process to prepare polyether-based polyurethane foams, placing the polyether-based polyurethane foams on the floor, and allowing an adult male having a weight of 85 kg to hit the polyether-based polyurethane foams 15 times with a hammer. As hitting results, the conventional polyether-based polyurethane foams were completely smashed within three times due to weak tensile force. On the other hand, polyether-based polyurethane foams prepared in Examples of the present invention were not broken, the polyether-based polyurethane foams were formed in such shapes that only surfaces of the foams hit by the hammer and bottom parts of the foams brought into contact with the floor were collapsed just as in the case of wood, wherein the polyether-based polyurethane foams themselves were not destroyed or sunk.

On the other hand, in case of Comparative Example 1 in which 100 weight parts of the undiluted latex solution was used with respect to 100 weight parts of the raw materials, it was hard to prepare a foam due to low miscibility.

Further, in case of the polyether-based polyurethane foam of Comparative Example 2 prepared without additional addition of the undiluted latex solution, the polyether-based polyurethane foam was entirely destroyed within 3 times of hitting when hitting of the polyether-based polyurethane foam was performed under the same severe conditions.

Thereafter, it was confirmed that the polyether-based polyurethane foam was capable of being lightly floated on water as general Styrofoam could be when floating a polyether-based polyurethane foam prepared in the present invention on water.

Therefore, a polyether-based polyurethane foam of the present invention was not broken or sunk even under severe impact conditions while maintaining characteristics of conventional polyether-based polyurethane foams since many foam cells were formed in the polyether-based polyurethane foam of the present invention such that a lightweight product could be prepared. Accordingly, a polyether-based polyurethane foam with improved strength of the present invention is used as floating material such that the polyether-based polyurethane foam can be used as building material, and the polyether-based polyurethane foam can reduce load of the weight when using the polyether-based polyurethane foam as building material.

As we examined above,

Firstly, the present invention provides a polyether-based polyurethane foam having improved strength which is a weak physical property in conventional polyether-based polyurethane foams by adding a composition for improving strength in a liquid phase to a urethane reaction process of mixing and reacting raw materials consisting of polyisocyanate and polyol, thereby maximizing miscibility between the composition and raw materials which react with each other.

Secondly, the present invention provides a polyether-based polyurethane foam economically and easily by adding a liquid functional composition only in the conventional reaction process, thereby enabling desired functionalities to be embodied.

Thirdly, a polyether-based polyurethane foam with improved strength of the present invention is used as wood-replacing material. Further, the polyether-based polyurethane foam of the present invention can reduce load of the weight when using the polyether-based polyurethane foam as floating material, thereby using the polyether-based polyurethane foam as building material. Uses for the building material usefully include soundproofing material for the building materials selected from an interlayer soundproofing material in the living space, an interlayer soundproofing partition in the office space, a soundproofing mat, and a sound

Fourthly, the polyether-based polyurethane foam with improved strength of the present invention can be usefully utilized as soundproofing material for automobiles.

Fifthly, the polyether-based polyurethane foam with improved strength of the present invention can be usefully utilized as insulating material.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A polyether-based polyurethane foam with improved strength, characterized in that 30 to 70 weight parts of a liquid composition for improving strength is added to 100 weight parts of raw materials consisting of polyisocyanate (—N═C═O) and polyol having at least two —OH groups at a terminal of a molecule, during a urethane reaction process which mixes and reacts with the raw materials such that the liquid composition for improving strength is foamed,
wherein the composition for improving strength is a liquid composition in which one or more materials selected from the group consisting of rubber, polyester, EVA (Ethylene Vinyl Acetate), and waste vinyl are dissolved into an organic solvent selected from petroleum-derived organic solvent and methyl ethyl ketone.

2-3. (canceled)

4. The polyether-based polyurethane foam with improved strength of claim 1, wherein the composition for improving strength encapsulates inner cells of the polyether-based polyurethane foam.

5. A method of preparing the polyether-based polyurethane foam, the method comprising:
mixing a liquid composition for improving strength with one of polyisocyanate (—N═C═O) and polyol having at least two —OH groups at a terminal of a molecule; additionally adding the liquid composition for improving strength to the raw materials consisting of polyisocyanate and polyol having at least two —OH groups at a terminal of a molecule to perform urethane reaction process, at the moment when the raw materials are being foamed through the urethane reaction;
drying and curing the resulting material, and
wherein the composition for improving strength is prepared by dissolving one or more materials selected from the group consisting of rubber, polyester, EVA (Ethylene Vinyl Acetate), and waste vinyl into an organic solvent selected from petroleum-derived organic solvent and methyl ethyl ketone.

6-7. (canceled)

8. The method of claim 5, wherein 30 to 70 weight parts of the composition for improving strength is added in 100 weight parts of the raw materials.

9. A soundproofing material for building materials and automobiles, characterized by using the polyether-based polyurethane foam with improved strength of claim 1.

10. An insulating material characterized by using the polyether-based polyurethane foam with improved strength of claim 1.
